(19) United States
(12) Patent Application Publication
(10) Pub. No.: US 2008/0226381 A1
(43) Pub. Date: Sep. 18, 2008

(54) Pen-like tool for presentations

(75) Inventor: Chih-Hung Chiu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 12/010,728

(22) Filed: Jan. 29, 2008

(30) Foreign Application Priority Data
Mar. 16, 2007 (TW) 96109077

(51) Int. Cl. B43K 29/00; B43K 24/02; H04R 11/04; H04B 7/00; B43K 7/12

(52) U.S. Cl. 401/195; 401/104; 381/361; 455/41.2

(57) ABSTRACT

A pen-like tool for presentations includes a main body and a Bluetooth transmission module. The Bluetooth transmission module is disposed in the main body. A metal clip is disposed on the main body and used as an antenna for the Bluetooth transmission module. The pen-like tool for presentations is able to improve the problem of carrying a lot of devices and the usability during presentations.

### CROSS REFERENCE TO RELATED APPLICATIONS

This Non-provisional application claims priority under 35 U.S.C. §119(a) on Patent Application No(s). 096109077, filed in Taiwan, Republic of China on Mar. 16, 2007, the entire contents of which are hereby incorporated by reference.

### BACKGROUND OF THE INVENTION

1. Field of the Invention

The invention relates to a tool for presentation and more particularly to a Bluetooth transmission module applied in a pen-like tool for presentation.

2. Description of the Related Art

Recently, since wireless technology achieves rapid advancement and has been applied in different applications, it becomes more convenient for people to communicate with each other. For example, an infrared pen-like tool prevents users from staying near the computer to operate. The users thus can control the computer in a long distance. Therefore, the pen-like tool increases the efficiency when users hold a meeting and becomes an indispensable tool for the businessperson nowadays.

Referring FIG. 1, FIG. 1 shows a block schematic diagram of a conventional pen-like tool for presentations. The conventional pen-like tool for presentations utilizes infrared technology to transmit signals. Thus, signals from a microprocessor 12 are transformed into infrared rays and to be transmitted to a computer 17 with presentation software via an infrared module 11 to proceed with a presentation. However, the use of infrared technology is limited to a predetermined direction and distance. Thus, there is a lot of limitations for using the conventional pen-like tool to present. In addition, if an interfering source 19, such as cell phones, PDAs or other electronic products are applied in similar frequency or surrounding with the conventional pen-like tool, the conventional interfering source 19 will make the computer 17 and the pen-like tool unable to transmit signals to each other. Moreover, lack of uniformity for infrared technology delays the development of infrared technology and causes great inconvenience for the user.

Meanwhile, a user also requires remote control functions, such as sound recording, sound amplifying, and indicating or other functions during a presentation. Thus, a speaker must prepare not only the conventional pen-like tool 1 but also other devices such as a microphone for recording or a laser pointer for pointing at the screen during a presentation. As a result, the speaker must prepare many devices, and it is very inconvenient for the speaker.

### BRIEF SUMMARY OF INVENTION

A detailed description is given in the following embodiments with reference to the accompanying drawings. The present invention provides a multi-functional pen-like tool for presentations which is easy to carry. In addition, the use of the pen-like tool has no concern about the limitation of direction, thus, improving the problem of interference.

To achieve the above, the present invention provides a pen-like tool for presentations comprising a main body and a Bluetooth transmission module. The main body has a clip made of metal and used as an antenna applied in the Bluetooth transmission. The Bluetooth transmission module is disposed in the main body.

The main body of the pen-like tool for presentations is assembled by an top shell and a bottom shell. The clip can be disposed on the top shell. The materials of the top shell and bottom shell are different. The top shell is made of macromolecular polymers. The bottom shell is made of a metal material and has an opening. A refill rotates and protrudes from the opening via twisting the bottom shell. The clip receives and transmits radio waves.

The pen-like tool for presentations further includes a microprocessor, a laser light source and a microphone. The Bluetooth transmission module includes a universal asynchronous receiver/transmitter or an inter-integrated circuit to transmit a signal to the microprocessor. The laser light source is controlled by another corresponding button to receive outer sounds. The microphone receiving an outer sound is controlled by a button. The pen-like tool remotely controls an electronic device. The electronic device includes a computer including an application software. The application software is applied to presentations or audio processes. The computer can further connect to an amplifier.

### BRIEF DESCRIPTION OF DRAWINGS

The present invention can be more fully understood by reading the subsequent detailed description and examples with references made to the accompanying drawings, wherein:

FIG. 1 is a block diagram of a conventional pen-like tool for presentations;

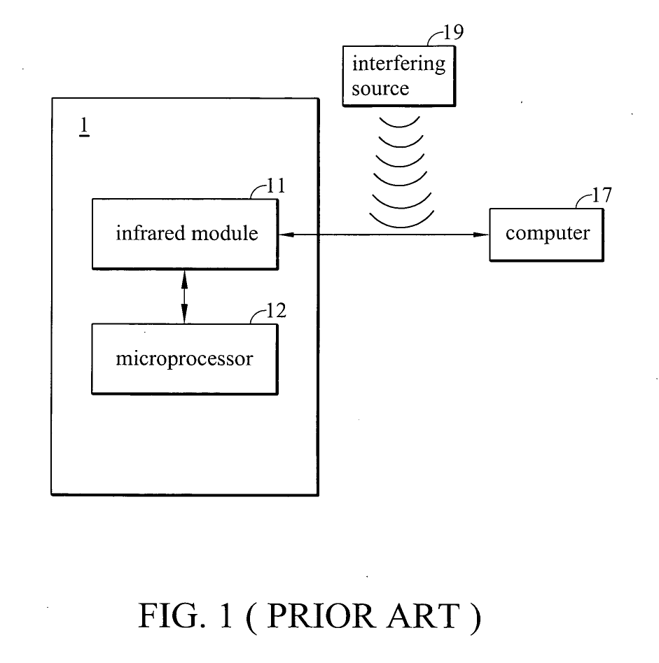

FIG. 2 is a block diagram of a pen-like tool for presentations of the present invention; and

FIG. 3 is a schematic illustration of a pen-like tool for presentations of the present invention.

### DETAILED DESCRIPTION OF INVENTION

The following description is one embodiment of the present invention. This description is made for the purpose of illustrating the general principles of the present invention and should not be taken in a limiting sense. The scope of the present invention is best determined by reference to the appended claims.

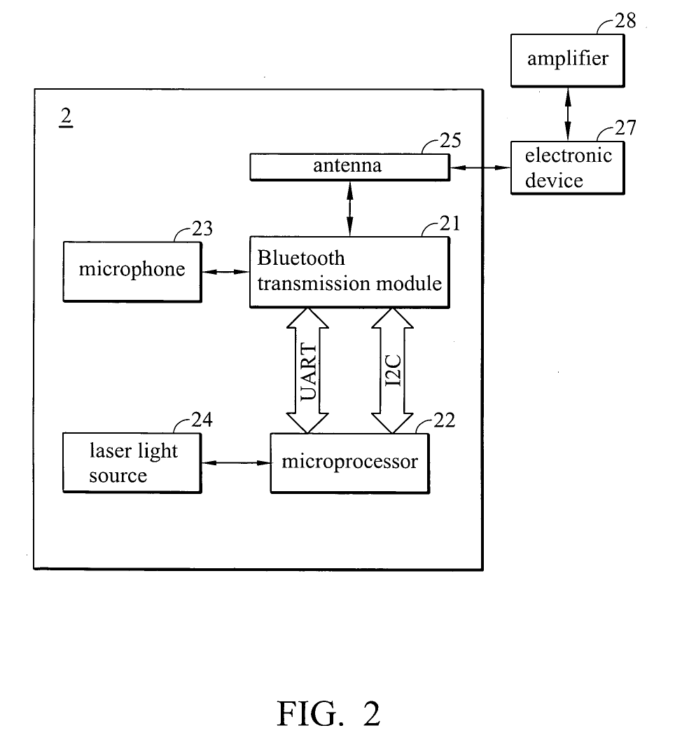

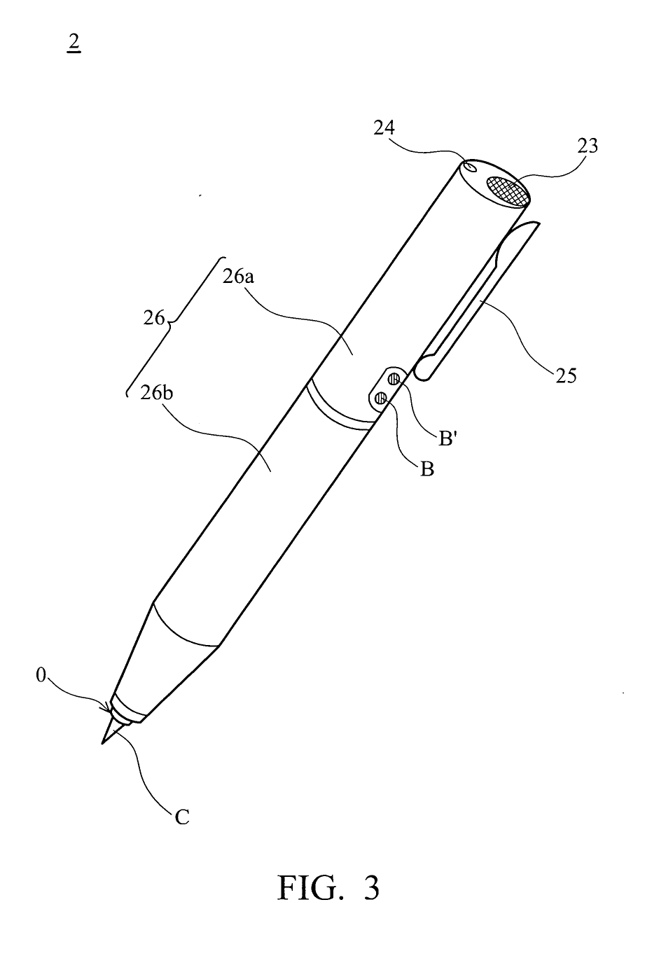

FIG. 2 is a block diagram of a pen-like tool for presentations of the present invention. FIG. 3 is a schematic illustration of a pen-like tool for presentations of the present invention. Referring to FIG. 3, a pen-like tool 2 for presentations includes a main body 26 and a Bluetooth transmission module 21 disposed in the main body 26. The main body 26 is assembled by a top shell 26a and a bottom shell 26b. The top shell 26a and bottom shell 26b are made of different materials. The main body 26 has a clip disposed on the top shell 26a. The clip is used as an antenna 25 of the Bluetooth transmission module 21 for transmitting and receiving radio signals. The top shell 26a can be made of macromolecular polymers and the bottom shell 26b with an opening 0 can be made of metal to prevent shield effect from influencing the antenna 25. The Bluetooth transmission module 21 has a universal asynchronous receiver/transmitter or an inter-integrated circuit to receive/transmit a signal from/to the microprocessor 22.

Furthermore, the pen-like tool 2 is provided not only for presentations but for other functions. If a user wants to switch on other functions, he or she can press buttons B and B′ disposed on the pen-like tool 2 to start other functions easily. The pen-like tool 2 includes a microphone 23. Thus, if the sound record function and sound amplifying function are used, pressing the button B starts the microphone 23 to receive a sound from the outside of the pen-like tool. The sound from the outside of the pen-like tool is transformed into a signal by an inner radio frequency circuit of the Bluetooth transmission module 21. The signal is transmitted to the electronic device 27 via the antenna 25. After an audio processing software of the electronic device 27 processes the signal, sounds are saved via the audio processing software. If the electronic device 27 is connected to an amplifier 28, for example a speaker, sound can be broadcasted. Furthermore, the pen-like tool 2 further includes a laser light source 24. If a user uses the indication function, the button B′ is pressed to reach what is being indicated. Compared with conventional pen-like tools, using the pen-like tool of the present invention avoids the trouble of bringing many devices for a presentation and provides a single common power source in the same device.

The Bluetooth transmission module 21 uses frequency-hopping transmission, thus, the electronic device 27, such as a computer, for remote control is not interfered by the same frequency band for radio frequencies. When the signal is transmitted from the pen-like tool 2 to the electronic device 27 and then the software of the electronic device 27 processes the signal, the pen-like tool 2 can remotely control presentation software, such as Microsoft PowerPoint. That is to say, the computer uses application software not only for providing audio processing but also for presentation. Compared with other radio frequency technologies, the pen-like tool 2 uses less power and with a longer duration.

Referring to FIG. 3, the pen-like tool 2 is used not only for presentations but also for writing. When a user easily twists the bottom shell 26b, a refill C rotates and protrudes from the opening 0. Thus, the pen-like tool 2 becomes a portable writing tool with stylish appearance. Thus, the usability of the pen-like tool 2 of the present invention is improved.

The pen-like tool 2 improves the problem of interference and the problem about the limitation of an indicated direction. The pen-like tool 2 has multi-functions to eliminate carrying many devices. The pen-like tool 2 is further used as a writing tool, thus, it is convenient for the businessperson.

While the present invention has been described by way of example and in terms of the preferred embodiments, it is to be understood that the present invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A pen-like tool for presentations, comprising:
a main body comprising a clip; and
a Bluetooth transmission module disposed in the main body;
wherein the clip comprises metal and functions as an antenna applied in the Bluetooth transmission module.

2. The pen-like tool for presentations as claimed in claim 1, wherein the main body is assembled by a top shell and a bottom shell and the clip is disposed on the top shell.

3. The pen-like tool for presentations as claimed in claim 2, wherein the top shell and bottom shell comprise different materials.

4. The pen-like tool for presentations as claimed in claim 3, wherein the top shell comprises macromolecular polymers.

5. The pen-like tool for presentations as claimed in claim 3, wherein the bottom shell comprises a metal.

6. The pen-like tool for presentations as claimed in claim 2, wherein the bottom shell comprises an opening.

7. The pen-like tool for presentations as claimed in claim 6, wherein a refill protrudes from the opening by rotating the bottom shell.

8. The pen-like tool for presentations as claimed in claim 1, wherein the clip receives and transmits at least one wireless signal.

9. The pen-like tool for presentations as claimed in claim 1, further comprising a microprocessor.

10. The pen-like tool for presentations as claimed in claim 9, wherein the Bluetooth transmission module comprises a universal asynchronous receiver/transmitter or an inter-integrated circuit to receive/transmit a signal from/to the microprocessor.

11. The pen-like tool for presentations as claimed in claim 1, further comprising a laser light source for indicating.

12. The pen-like tool for presentations as claimed in claim 11, further comprising a button to control the laser light source.

13. The pen-like tool for presentations as claimed in claim 1, further comprising a microphone.

14. The pen-like tool for presentations as claimed in claim 13, wherein the microphone receives sounds from outside of the pen-like tool.

15. The pen-like tool for presentations as claimed in claim 14, further comprising a button to control the microphone.

16. The pen-like tool for presentations as claimed in claim 1, the pen-like tool remotely controls an electronic device.

17. The pen-like tool for presentations as claimed in claim 16, wherein the electronic device is a computer.

18. The pen-like tool for presentations as claimed in claim 17, wherein the computer uses application software for presentation.

19. The pen-like tool for presentations as claimed in claim 17, wherein the computer uses application software for providing audio processing.

20. The pen-like tool for presentations as claimed in claim 16, further comprising an amplifier to connect to the electronic device.
